(19) United States
(12) Patent Application Publication
(10) Pub. No.: US 2026/0254825 A1
(43) Pub. Date: Aug. 27, 2026

(54) MACHINE-LEARNING BASED (ML-BASED) SYSTEM AND METHOD FOR AUTOMATICALLY DETECTING ANOMALIES

(71) Applicant: SISA Information Security Pvt Ltd, Bengaluru (IN)

(72) Inventors: Mahendran Chandramohan, Bangalore (IN); Ajit Venigala, Bangalore (IN); Ganeshvel Manignadhi, Bangalore (IN); Pradyumna Kumar Sahu, Bangalore (IN); Balan Muthusamy, Bangalore (IN)

(21) Appl. No.: 19/062,146

(22) Filed: Feb. 25, 2025

(51) Int. Cl. H04L 9/40; G06N 20/00

(52) U.S. Cl. CPC H04L 63/1425; G06N 20/00; H04L 63/1416

(57) ABSTRACT

A machine-learning based (ML-based) system and method for automatically detecting anomalies are disclosed. The ML-based method comprises (a) obtaining data associated with logs from log data sources; (b) identifying malicious activities from the logs, by at least one of: (i) analyzing the data associated with the logs, using an alarm engine, (ii) correlating each log with the logs, using a correlation engine with the predefined analysis and detection rules, and (iii) analyzing the data that are obtained over a predetermined time duration to identify the malicious activities in user and entity behaviours, using a UEBA engine with ML models; (c) correlating alerts associated with malicious activities that are identified from the engines, with historical alerts associated with historical malicious activities, to detect patterns and trends indicating the anomalies, using an XTD engine; and (d) providing the anomalies, as an output, to end users.

### FIELD OF INVENTION

Embodiments of the present disclosure relate to machine learning-based (ML-based) detecting systems and more particularly relate to a machine-learning based (ML-based) system and method for automatically detecting one or more anomalies (e.g., one or more malicious activities and one or more threats).

### BACKGROUND

Threat Detection Systems are technologies, tools, or solutions designed to identify, monitor, and respond to potential security threats within an organization's infrastructure. These threat detection systems work by analyzing user behavior, network traffic, or system logs to detect anomalies, vulnerabilities, or malicious activities that could compromise data, assets, or operational integrity.

Current threat detection systems often face challenges with precision, leading to frequent occurrences of false positives (incorrectly flagging harmless activities as threats) and false negatives (failing to identify actual threats).

Sophisticated cyber threats, such as advanced persistent threat (APT) groups and ransomware attackers, frequently bypass detection by taking advantage of the limitations of single-method detection systems. These actors may remain inactive for prolonged durations, often spanning weeks, before initiating their attacks, effectively outmaneuvering traditional detection approaches and exposing critical gaps in security defenses.

Further, a rapid advancement of cyber threats surpasses the capabilities of static detection methods, rendering these threat detection systems unable to adapt quickly or respond effectively to novel and evolving threats.

Contemporary organizations navigate a highly intricate threat landscape where cyber and physical risks frequently converge, presenting challenges that traditional security solutions struggle to address effectively. While many organizations utilize specialized tools tailored to specific domains, such as Fraud and Risk Management in FinTech, Physical Security Information Management (PSIM) systems, and Endpoint Detection and Response (EDR) solutions, these systems typically function in isolation. This fragmented approach restricts their ability to deliver a unified and comprehensive assessment of an organization's overall security posture.

Therefore, there is a need for a machine-learning based (ML-based) system and method for automatically detecting one or more anomalies, in order to address the aforementioned issues.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

In accordance with an embodiment of the present disclosure, a machine-learning based (ML-based) method for automatically detecting one or more anomalies, is disclosed.

The ML-based method comprises obtaining, by one or more hardware processors, data associated with one or more logs from one or more log data sources.

The ML-based method further comprises identifying, by the one or more hardware processors, one or more malicious activities from the one or more logs, by at least one of: (a) analyzing, by the one or more hardware processors, the data associated with the one or more logs to identify the one or more malicious activities using an alarm engine with predefined analysis and detection rules; and (b) correlating, by the one or more hardware processors, each log with the one or more logs to identify the one or more malicious activities, using a correlation engine with the predefined analysis and detection rules; and (c) analyzing, by the one or more hardware processors, the data associated with the one or more logs that are obtained over a predetermined time duration to identify the one or more malicious activities in at least one of: one or more user behaviours and one or more entity behaviours, using a user and entity behaviour analytics (UEBA) engine with one or more machine learning (ML) models.

The ML-based method further comprises correlating, by the one or more hardware processors, one or more alerts associated with the one or more malicious activities that are identified from at least one of: the alarm engine, the correlation engine, a threat engine, the UEBA engine, with one or more historical alerts associated with one or more historical malicious activities, to detect one or more patterns and trends indicating the one or more anomalies, using an extended threat detection engine.

The ML-based method further comprises providing, by the one or more hardware processors, the one or more anomalies, as an output, to one or more end users on one or more user interfaces associated with one or more electronic devices associated with the one or more end users.

In an embodiment, identifying the one or more malicious activities using the alarm engine, comprises: (a) obtaining, by the one or more hardware processors, the data associated with the one or more logs from the one or more log data sources; (b) comparing, by the one or more hardware processors, the data associated with the one or more logs, with the predefined analysis and detection rules; and (c) identifying, by the one or more hardware processors, the one or more malicious activities upon comparison of the data associated with the one or more logs, with the predefined analysis and detection rules.

In yet another embodiment, identifying the one or more malicious activities using the correlation engine, comprises: (a) obtaining, by the one or more hardware processors, the data associated with the one or more logs from the one or more log data sources; (b) correlating, by the one or more hardware processors, each event associated with each log, with one or more events associated with the one or more logs; (c) analyzing, by the one or more hardware processors, one or more relationships and patterns among the one or more events associated with the one or more logs over a predetermined time window, upon comparison of each event associated with each log, with the one or more events associated with the one or more logs; and (d) identifying, by the one or more hardware processors, the one or more malicious activities based on the analysis of the one or more relationships and patterns among the one or more events, using the correlation engine.

In yet another embodiment, the ML-based method further comprises: (a) utilizing, by the one or more hardware processors, at least one of: one or more external threat intelligent sources and one or more internal threat intelligent sources, for identifying the one or more malicious activities and one or more threats, using the threat engine; and (b) integrating, by the one or more hardware processors, the one or more external threat intelligent sources and one or more internal threat intelligent sources, to optimize a process of identifying the one or more malicious activities and the one or more threats, using the threat engine.

In yet another embodiment, identifying the one or more malicious activities in at least one of: the one or more user behaviours and the one or more entity behaviours, using the UEBA engine, comprises: (a) obtaining, by the one or more hardware processors, the one or more alerts associated with the one or more malicious activities, generated from the one or more ML models, wherein the one or more ML models comprise at least one of: a login anomaly based ML model, a process anomaly based ML model, a geo location anomaly based ML model, a lateral movement based ML model, and a privilege escalation based ML model; (b) generating, by the one or more hardware processors, one or more individual risk scores with one or more individual weights for one or more alerts generated by each ML model of the one or more ML models, based on severity and context of the one or more malicious activities; (c) computing, by the one or more hardware processors, one or more overall risk scores with one or more overall weights for one or more combinations of the one or more alerts generated by the one or more ML models, based on the severity and context of the one or more malicious activities; and (d) identifying, by the one or more hardware processors, the one or more malicious activities based on an optimized risk score with optimized weight among the one or more overall risk scores with the one or more overall weights computed for the one or more combinations of the one or more alerts.

In yet another embodiment, the ML-based method further comprises training, by the one or more hardware processors, the one or more ML models within the UEBA engine, by: (a) obtaining, by the one or more hardware processors, one or more training datasets associated with one or more baseline logs for at least one of: the one or more user behaviours and the one or more entity behaviours, wherein the one or more training datasets associated with the one or more baseline logs indicate at least one of: one or more regular patterns comprising at least one of: system interactions, process executions, and critical activity frequencies; (b) analyzing, by the one or more hardware processors, frequency and context of interactions with at least one of: one or more system processes, one or more critical processes, and one or more activities; and (c) clustering, by the one or more hardware processors, at least one of: one or more users and one or more entities, into one or more groups based on at least one of: one or more internal rules and the one or more training datasets associated with the one or more baseline logs, for identifying and segmenting the one or more malicious activities and the one or more threats.

In yet another embodiment, the ML-based method further comprises re-training, by the one or more hardware processors, the one or more ML models within the UEBA engine, by: (a) continuously assessing, by the one or more hardware processors, the one or more baseline logs for at least one of: the one or more user behaviours and the one or more entity behaviours to indicate one or more dynamic changes in at least one of: the one or more user behaviours and the one or more entity behaviours; (b) continuously monitoring, by the one or more hardware processors, at least one of: the one or more user behaviours and the one or more entity behaviours, to validate performance of the one or more ML models based on one or more feedback received from one or more analysts; (c) updating, by the one or more hardware processors, one or more categories associated with the one or more malicious activities, to synchronize with current organizational and operational needs, wherein the one or more categories associated with the one or more malicious activities comprise at least one of: system, critical and non-critical; (d) fine-tuning, by the one or more hardware processors, the one or more ML models to optimize adaptability and mitigate false positives based on the one or more feedback received from the one or more analysts; and (e) re-training, by the one or more hardware processors, the one or more ML models with updated data associated with the one or more logs to determine for changes in at least one of: the one or more user behaviours and the one or more entity behaviours.

In yet another embodiment, the ML-based method further comprises: (a) obtaining, by the one or more hardware processors, the one or more alerts associated with the one or more malicious activities, from one or more engines comprising at least one of: the alarm engine, the correlation engine, the threat engine, and the UEBA engine; and (b) transforming, by the one or more hardware processors, one or more formats of the one or more alerts into one or more actionable insights in a common format, using a cross-domain alert converter engine.

In one aspect, a machine learning based (ML-based) system for automatically detecting one or more anomalies, is disclosed. The ML-based system includes the one or more hardware processors, and a memory coupled to the one or more hardware processors. The memory includes a plurality of subsystems in the form of programmable instructions executable by the one or more hardware processors.

The plurality of subsystems comprises a data obtaining subsystem configured to obtain data associated with one or more logs from one or more log data sources.

The plurality of subsystems comprises a malicious activities identifying subsystem configured to identify one or more malicious activities from the one or more logs by at least one of: (a) analyzing the data associated with the one or more logs to identify the one or more malicious activities using an alarm engine with predefined analysis and detection rules; (b) correlating each log with the one or more logs to identify the one or more malicious activities, using a correlation engine with the predefined analysis and detection rules; and (c) analyzing, by the one or more hardware processors, the data associated with the one or more logs that are obtained over a predetermined time duration to identify the one or more malicious activities in at least one of: one or more user behaviours and one or more entity behaviours, using a user and entity behaviour analytics (UEBA) engine with one or more machine learning (ML) models.

The plurality of subsystems comprises an anomaly detecting subsystem configured to correlate one or more alerts associated with the one or more malicious activities that are identified from at least one of: the alarm engine, the correlation engine, a threat engine, the UEBA engine, with one or more historical alerts associated with one or more historical malicious activities, to detect one or more patterns and trends indicating the one or more anomalies, using an extended threat detection engine.

The plurality of subsystems comprises an output subsystem configured to provide the one or more anomalies, as an output, to one or more end users on one or more user interfaces associated with one or more electronic devices associated with the one or more end users.

In another aspect, a non-transitory computer-readable storage medium having instructions stored therein that, when executed by a hardware processor, causes the processor to perform method steps as described above.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF DRAWINGS

The disclosure will be described and explained with additional specificity and detail with the accompanying figures in which:

FIG. 1 is a block diagram illustrating a computing environment with a machine learning based (ML-based) system for automatically detecting one or more anomalies (e.g., one or more malicious activities and one or more threats), in accordance with an embodiment of the present disclosure;

FIG. 2 is a detailed view of the ML-based system for automatically detecting the one or more anomalies, in accordance with an embodiment of the present disclosure;

FIG. 3 is an exemplary view depicting a detection of the one or more anomalies in one or more user behaviours, in accordance with an embodiment of the present disclosure;

FIG. 4 is an exemplary view depicting a detection of the one or more anomalies in one or more entity behaviours, in accordance with an embodiment of the present disclosure;

FIG. 5 is a process flow depicting a detection of one or more patterns and trends indicating the one or more anomalies, using an extended threat detection engine, in accordance with an embodiment of the present disclosure; and

FIG. 6 is a flow chart illustrating a ML-based method for automatically detecting the one or more anomalies, in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION OF THE DISCLOSURE

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

The terms “comprise”, “comprising”, or any other variations thereof, are intended to cover a non-exclusive inclusion, such that one or more devices or sub-systems or elements or structures or components preceded by “comprises . . . a“ does not, without more constraints, preclude the existence of other devices, sub-systems, additional sub-modules. Appearances of the phrase ”in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

A computer system (standalone, client or server computer system) configured by an application may constitute a “module” (or “subsystem”) that is configured and operated to perform certain operations. In one embodiment, the “module” or “subsystem” may be implemented mechanically or electronically, so a module include dedicated circuitry or logic that is permanently configured (within a special-purpose processor) to perform certain operations. In another embodiment, a “module” or “subsystem” may also comprise programmable logic or circuitry (as encompassed within a general-purpose processor or other programmable processor) that is temporarily configured by software to perform certain operations.

Accordingly, the term “module” or “subsystem” should be understood to encompass a tangible entity, be that an entity that is physically constructed permanently configured (hardwired) or temporarily configured (programmed) to operate in a certain manner and/or to perform certain operations described herein.

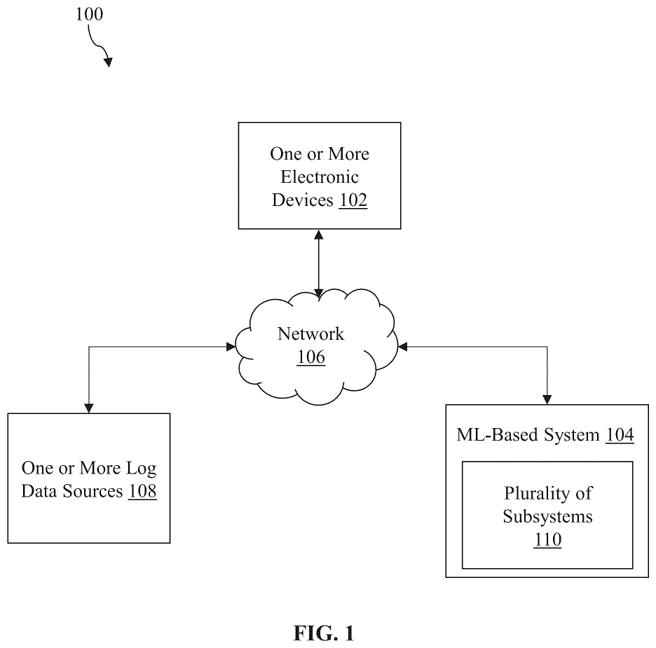

Referring now to the drawings, and more particularly to FIG. 1 through FIG. 6, where similar reference characters denote corresponding features consistently throughout the figures, there are shown preferred embodiments, and these embodiments are described in the context of the following exemplary system and/or method.

FIG. 1 is a block diagram illustrating a computing environment 100 with a machine learning based (ML-based) system 104 for automatically detecting one or more anomalies, in accordance with an embodiment of the present disclosure.

According to an exemplary embodiment of the present disclosure, the computing environment 100 may include one or more electronic devices 102, the ML-based system 104, and one or more data sources 108 (i.e., one or more log data sources). The terms “one or more data sources 108” and “the one or more log data sources” are used interchangeably throughout the description. According to FIG. 1, the computing environment 100 includes the one or more electronic devices 102 that are communicatively coupled to the ML-based system 104 through a network 106. The one or more electronic devices 102 through which one or more end users receive output results from the ML-based system 104.

The present invention is configured to automatically detect the one or more anomalies (e.g., one or more malicious activities and one or more threats). The ML-based system 104 is initially configured to obtain data associated with one or more logs from one or more log data sources in real-time. In an embodiment, the data may be encrypted and decrypted by the ML-based system 104, so that one or more third party users cannot be authenticated to manipulate the data.

The ML-based system 104 is further configured to analyze the data associated with the one or more logs to identify the one or more malicious activities using an alarm engine with predefined analysis and detection rules. The ML-based system 104 is further configured to correlate each log with the one or more logs to identify the one or more malicious activities, using a correlation engine with the predefined analysis and detection rules. The ML-based system 104 is further configured to analyze the data associated with the one or more logs that are obtained over a predetermined time duration to identify the one or more malicious activities in at least one of: one or more user behaviours and one or more entity behaviours, using a user and entity behaviour analytics (UEBA) engine with one or more machine learning (ML) models.

The ML-based system 104 is further configured to utilize at least one of: one or more external threat intelligent sources and one or more internal threat intelligent sources, for identifying the one or more malicious activities and one or more threats, using a threat engine. The ML-based system 104 is further configured to correlate one or more alerts associated with the one or more malicious activities that are identified from at least one of: the alarm engine, the correlation engine, the threat engine, the UEBA engine, with one or more historical alerts associated with one or more historical malicious activities, to detect one or more patterns and trends indicating the one or more anomalies, using an extended threat detection (XTD) engine. The ML-based system 104 is further configured to provide the one or more anomalies, as an output, to the one or more end users on one or more user interfaces associated with one or more electronic devices 102 associated with the one or more end users.

In an exemplary embodiment, the ML-based system 104 may be deployed via one or more servers. The one or more servers comprise one or more hardware processors and a memory unit that includes a set of computer-readable instructions executable by the one or more hardware processors to automatically detect the one or more anomalies.

In another exemplary embodiment, the ML-based system 104 provides flexible deployment options to meet one or more customer requirements, ensuring scalability and adaptability for one or more environments. The ML-based system 104 may be deployed in a cloud infrastructure where the ML-based system 104 is fully hosted. The cloud infrastructure is ideal for the one or more end users seeking a managed solution with minimal operational overhead. The ML-based system 104 may be deployed within the customer's environment, either in their data center or cloud infrastructure. The on-premises deployment is configured for organizations with strict compliance or data residency requirements. The ML-based system 104 may be deployed in a hybrid deployment that is a combination of the cloud infrastructure and end user's environment. The hybrid deployment enables flexible resource allocation, allowing critical components to reside on-premises while leveraging cloud scalability for other functions. These deployment models may provide organizations with the ability to choose the setup that best aligns with their operational, security, and compliance needs.

The one or more hardware processors may comprise a combination of discrete components, an integrated circuit, an application-specific integrated circuit, a field-programmable gate array, a digital signal processor, or other suitable one or more hardware processors and a software. The “software” may comprise one or more objects, agents, threads, lines of code, subroutines, separate software applications, two or more lines of code, or other suitable software structures operating in one or more software applications or the one or more hardware processors. The memory unit is operatively connected to the one or more hardware processors. The memory unit comprises the set of computer-readable instructions in form of a plurality of subsystems 110, configured to be executed by the one or more hardware processors.

In an exemplary embodiment, the one or more hardware processors may include, for example, microprocessors, microcomputers, microcontrollers, digital signal processors, central processing units, state machines, logic circuits, and/or any devices that manipulate data or signals based on operational instructions. Among other capabilities, the one or more hardware processors may fetch and execute computer-readable instructions in the memory unit operationally coupled with the ML-based system 104 for automatically detecting the one or more anomalies. The one or more hardware processors is high-performance processors capable of handling large volumes of data and complex computations. The one or more hardware processors may be, but not limited to, at least one of: multi-core central processing units (CPU), graphics processing units (GPUs), and specialized Artificial Intelligence (AI) accelerators that enhance an ability of the ML-based system 104 to process real-time data from a plurality of sources simultaneously.

In an exemplary embodiment, the one or more data sources 108 may configured to store, and manage data related to various aspects of the ML-based system 104. The one or more data sources 108 may include different types of databases such as, but not limited to, relational databases (e.g., Structured Query Language (SQL) databases), non-Structured Query Language (NoSQL) databases (e.g., MongoDB, Cassandra), time-series databases (e.g., InfluxDB), an OpenSearch database, object storage systems (e.g., Amazon S3, PostgresDB), and the like. The one or more data sources 108 play a critical role in ensuring the adaptability and scalability of the ML-based system 104 by providing comprehensive data support for both initial ML model training and ongoing ML-based system 104 updates.

In an exemplary embodiment, the one or more electronic devices 102 are configured to enable the one or more users to interact with the ML-based system 104. The one or more electronic devices 102 may be digital devices, computing devices, and/or networks. The one or more electronic devices 102 may include, but not limited to, a mobile device, a smartphone, a personal digital assistant (PDA), a tablet computer, a phablet computer, a wearable computing device, a virtual reality/augmented reality (VR/AR) device, a laptop, a desktop, and the like. The one or more electronic devices 102 are configured with a user interface configured to enable seamless interaction between the one or more end users and the ML-based system 104. The user interface may include the graphical user interfaces (GUIs), voice-based interfaces, and touch-based interfaces, depending on the capabilities of the one or more electronic devices 102 being used.

The one or more users may also include Information Technology (IT) administrators and personnels responsible for managing the ML-based system 104, as well as decision-makers or executives. In an exemplary embodiment, the networks 106 may be, but not limited to, a wired communication network and/or a wireless communication network, a local area network (LAN), a wide area network (WAN), a Wireless Local Area Network (WLAN), a metropolitan area network (MAN), a telephone network, such as the Public Switched Telephone Network (PSTN) or a cellular network, an intranet, the Internet, a fibre optic network, a satellite network, a cloud computing network, or a combination of networks. The wired communication network may comprise, but not limited to, at least one of: Ethernet connections, Fiber Optics, Power Line Communications (PLCs), Serial Communications, Coaxial Cables, Quantum Communication, Advanced Fiber Optics, Hybrid Networks, and the like. The wireless communication network may comprise, but not limited to, at least one of: wireless fidelity (wi-fi), cellular networks (including fourth generation (4G) technologies and fifth generation (5G) technologies), Bluetooth, ZigBee, long-range wide area network (LoRaWAN), satellite communication, radio frequency identification (RFID), 6G (sixth generation) networks, advanced IoT protocols, mesh networks, non-terrestrial networks (NTNs), near field communication (NFC), and the like.

In an exemplary embodiment, the ML-based system 104 may be implemented by way of a single device or a combination of multiple devices that may be operatively connected or networked together. The ML-based system 104 may be implemented in hardware or a suitable combination of hardware and software.

Though few components and the plurality of subsystems 110 are disclosed in FIG. 1, there may be additional components and subsystems which is not shown, such as, but not limited to, ports, routers, repeaters, firewall devices, network devices, network attached storage devices, assets, machinery, instruments, facility equipment, emergency management devices, image capturing devices, any other devices, and combination thereof. The person skilled in the art should not be limiting the components/subsystems shown in FIG. 1. Although FIG. 1 illustrates the ML-based system 104, and the one or more one or more electronic devices 102 connected to the one or more data sources 108, one skilled in the art can envision that the ML-based system 104, and the one or more electronic devices 102 may be connected to several end user devices located at various locations and several databases via the network 106.

Those of ordinary skilled in the art will appreciate that the hardware depicted in FIG. 1 may vary for particular implementations. For example, other peripheral devices such as an optical disk drive and the like, the local area network (LAN), the wide area network (WAN), wireless (e.g., wireless-fidelity (Wi-Fi)) adapter, graphics adapter, disk controller, input/output (I/O) adapter also may be used in addition or place of the hardware depicted. The depicted example is provided for explanation only and is not meant to imply architectural limitations concerning the present disclosure.

Those skilled in the art will recognize that, for simplicity and clarity, the full structure and operation of all data processing systems suitable for use with the present disclosure are not being depicted or described herein. Instead, only so much of the ML-based system 104 as is unique to the present disclosure or necessary for an understanding of the present disclosure is depicted and described. The remainder of the construction and operation of the ML-based system 104 may conform to any of the various current implementations and practices that were known in the art.

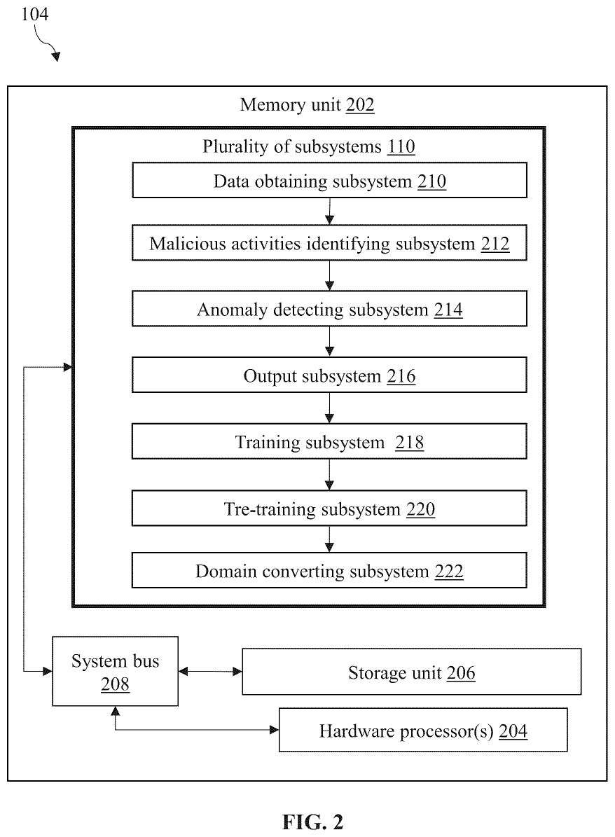

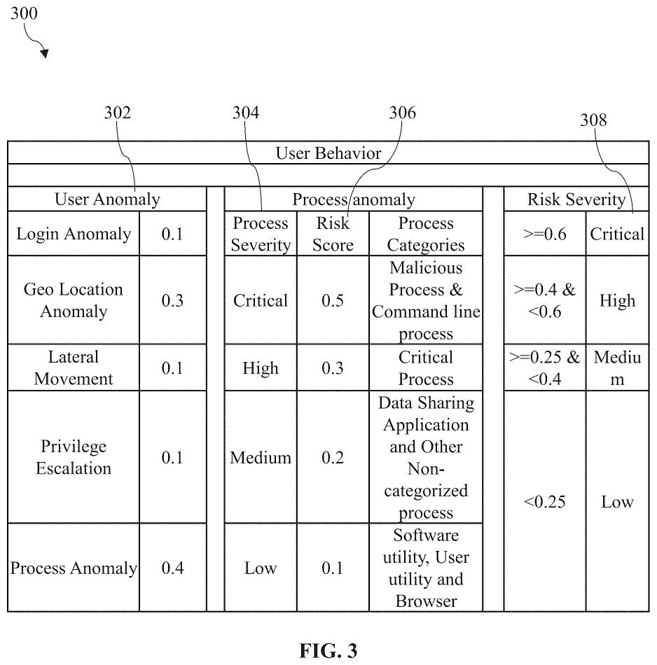

FIG. 2 is a detailed view of the ML-based system 104 for automatically detecting the one or more anomalies, in accordance with an embodiment of the present disclosure.

The ML-based system 104 includes the memory unit 202, the one or more hardware processors 204, and a storage unit 206. The memory unit 202, the one or more hardware processors 204, and the storage unit 206 are communicatively coupled through a system bus 208 or any similar mechanism. The memory unit 202 includes the plurality of subsystems 110 in the form of programmable instructions executable by the one or more hardware processors 204. The system bus 208 facilitates the efficient exchange of information and instructions, enabling the coordinated operation of the ML-based system 104. The system bus 208 may be implemented using various technologies, including but not limited to, parallel buses, serial buses, or high-speed data transfer interfaces such as, but not limited to, at least one of a: universal serial bus (USB), peripheral component interconnect express (PCIe), and similar standards.

In an exemplary embodiment, the memory unit 202 is operatively connected to the one or more hardware processors 204. The memory unit 202 comprises the plurality of subsystems 110 in the form of programmable instructions executable by the one or more hardware processors 204. The plurality of subsystems 110 comprises a data obtaining subsystem 210, a malicious activities identifying subsystem 212, an anomaly detecting subsystem 214, an output subsystem 216, a training subsystem 218, a re-training subsystem 220, and a domain converting subsystem 222.

The one or more hardware processors 204, as used herein, means any type of computational circuit, such as, but not limited to, the microprocessor unit, microcontroller, complex instruction set computing microprocessor unit, reduced instruction set computing microprocessor unit, very long instruction word microprocessor unit, explicitly parallel instruction computing microprocessor unit, graphics processing unit, digital signal processing unit, or any other type of processing circuit. The one or more hardware processors 204 may also include embedded controllers, such as generic or programmable logic devices or arrays, application-specific integrated circuits, single-chip computers, and the like.

The memory unit 202 may be the non-transitory volatile memory and the non-volatile memory. The memory unit 202 may be coupled to communicate with the one or more hardware processors 204, such as being a computer-readable storage medium. The one or more hardware processors 204 may execute machine-readable instructions and/or source code stored in the memory unit 202. A variety of machine-readable instructions may be stored in and accessed from the memory unit 202. The memory unit 202 may include any suitable elements for storing data and machine-readable instructions, such as read-only memory, random access memory, erasable programmable read-only memory, electrically erasable programmable read-only memory, a hard drive, a removable media drive for handling compact disks, digital video disks, diskettes, magnetic tape cartridges, memory cards, and the like. In the present embodiment, the memory unit 202 includes the plurality of subsystems 110 stored in the form of machine-readable instructions on any of the above-mentioned storage media and may be in communication with and executed by the one or more hardware processors 204.

The storage unit 206 may be a cloud storage or the one or more data sources 108 such as those shown in FIG. 1. The storage unit 206 may store, but not limited to, recommended course of action sequences dynamically generated by the ML-based system 104. These action sequences may comprise at least one of: identification of the one or more malicious activities, correlation of the alerts to detect the one or more anomalies, training and re-training of the ML model, and the like. The dynamically generated action sequences may be used to optimize the evaluation of the ML-based system 104, improve response accuracy, enhance accuracy of detecting the one or more anomalies using the ML-based system 104. Additionally, the storage unit 206 may retain previous action sequences for comparison and future reference, enabling continuous refinement of the ML-based system 104 over time. The storage unit 206 may be any kind of database such as, but not limited to, relational databases, dedicated databases, dynamic databases, monetized databases, scalable databases, cloud databases, distributed databases, any other databases, and a combination thereof.

The plurality of subsystems 110 includes the data obtaining subsystem 210 that is communicatively connected to the one or more hardware processors 204. The data obtaining subsystem 210 is configured to obtain the data associated with one or more logs from one or more log data sources. In an embodiment, the data associated with one or more logs are obtained from the one or more log data sources in real time. The data obtaining subsystem 210 operates as a foundational component of the ML-based system 104, enabling seamless integration with various input sources to retrieve the one or more logs.

The plurality of subsystems 110 further includes the malicious activities identifying subsystem 212 that is communicatively connected to the one or more hardware processors 204. The malicious activities identifying subsystem 212 is configured to analyze the data associated with the one or more logs to identify the one or more malicious activities using the alarm engine with predefined analysis and detection rules.

For identifying the one or more malicious activities using the alarm engine, the malicious activities identifying subsystem 212 is initially configured to obtain the data associated with the one or more logs from the one or more log data sources. The malicious activities identifying subsystem 212 is further configured to compare the data associated with the one or more logs, with the predefined analysis and detection rules. The malicious activities identifying subsystem 212 is further configured to identify the one or more malicious activities upon comparison of the data associated with the one or more logs, with the predefined analysis and detection rules.

In an embodiment, upon comparison within the data associated with the one or more logs, the malicious activities identifying subsystem 212 with the alarm engine is configured to automatically optimize/enrich the one or more logs with additional threat intelligence and contextual information. The optimized/enriched one or more logs may be accessible to one or more security analysts being adapted to validate the one or more logs and provide appropriate remedial actions for the detected one or more malicious activities. Based on the prompt detection and enrichment, the malicious activities identifying subsystem 212 with the alarm engine is configured to perform swift identification of potential threats and to significantly improve response times.

The malicious activities identifying subsystem 212 is further configured to correlate each log with the one or more logs to identify the one or more malicious activities, using the correlation engine with the predefined analysis and detection rules. For identifying the one or more malicious activities using the correlation engine, the malicious activities identifying subsystem 212 is initially configured to obtain the data associated with the one or more logs from the one or more log data sources. The malicious activities identifying subsystem 212 is further configured to correlate each event associated with each log, with one or more events associated with the one or more logs.

The malicious activities identifying subsystem 212 is further configured to analyze one or more relationships and patterns among the one or more events associated with the one or more logs over a predetermined time window (e.g., three minute time window), upon comparison of each event associated with each log, with the one or more events associated with the one or more logs. In other words, the malicious activities identifying subsystem 212 with the correlation engine is configured to analyze the one or more relationships and patterns among seemingly isolated events, uncovering potential advanced attacks that are unnoticed in single-event analysis.

The malicious activities identifying subsystem 212 is further configured to identify the one or more malicious activities based on the analysis of the one or more relationships and patterns among the one or more events, using the correlation engine. Upon correlation is performed, the malicious activities identifying subsystem 212 with the correlation engine is configured to optimize the identified events (e.g., the one or more logs) with detailed threat information that is provided to the one or more analysts with a more comprehensive view for perform validation/investigation and actions for the identified malicious activities.

The malicious activities identifying subsystem 212 is further configured to analyze the data associated with the one or more logs that are obtained over the predetermined time duration (e.g., 15-minute duration against the baseline logs) to identify the one or more malicious activities in at least one of: the one or more user behaviours and the one or more entity behaviours, using the user and entity behaviour analytics (UEBA) engine with the one or more machine learning (ML) models. In an embodiment, each anomaly model operates independently to generate the one or more alerts based on one or more deviations from normal behaviour. The user and entity behaviour analytics (UEBA) engine is configured to combine the one or more alerts generated by the one or more ML models to provide a comprehensive view of at least one of: the one or more user behaviours and the one or more entity behaviours.

For identifying the one or more malicious activities in at least one of: the one or more user behaviours and the one or more entity behaviours, using the UEBA engine, the malicious activities identifying subsystem 212 is initially configured to obtain the one or more alerts associated with the one or more malicious activities, generated from the one or more ML models. In an embodiment, the one or more ML models may include at least one of: a login anomaly based ML model, a process anomaly based ML model, a geo location anomaly based ML model, a lateral movement based ML model, and a privilege escalation based ML model.

The user and entity behaviour analytics (UEBA) engine is configured to generate one or more individual risk scores with one or more individual weights for one or more alerts generated by each ML model of the one or more ML models, based on severity and context of the one or more malicious activities. For example, the UEBA engine is configured to allow the login anomaly to contribute the individual risk score with individual weight based on the log in by the user.

The UEBA engine is further configured to compute one or more overall risk scores with one or more overall weights for one or more combinations of the one or more alerts generated by the one or more ML models, based on the severity and context of the one or more malicious activities. For example, if a user logs in from a different geographical location (i.e., geo location anomaly) but at an expected time (i.e., login anomaly) and accesses typical processes (i.e., process anomaly), then the UEBA engine is configured to compute the overall risk score that might be lower. Conversely, if all anomalies occur together (e.g., unusual login time, from an unusual location, accessing unusual processes, and moving laterally within the network), then the UEBA engine is configured to compute the overall risk score that may be significantly higher, triggering a more urgent response.

The UEBA engine is further configured to identify the one or more malicious activities based on an optimized risk score with optimized weight among the one or more overall risk scores with the one or more overall weights computed for the one or more combinations of the one or more alerts. In other words, the one or more alerts with optimized risk score and optimized weight are prioritized for investigation, which causes to reduce the number of false positives that security teams need to address. The prioritization using the UEBA engine allows for a more efficient allocation of resources, focusing on potential threats that represent a higher risk.

In an embodiment, the UEBA engine is configured to utilize data exfiltration technique to identify the one or more malicious activities when the user or entity involves in unusual or unauthorized data transfer activities. In another embodiment, the UEBA engine is further configured to utilize reconnaissance technique to identify the one or more malicious activities when the user or entity performs unusual scanning activities, including port or vulnerability scans.

The plurality of subsystems 110 further includes the training subsystem 218 that is communicatively connected to the one or more hardware processors 204. The training subsystem 218 is configured to train the one or more ML models. The ML-based system 104 may utilize K-Prototype method for clustering one or more users and one or more devices, enabling efficient handling of mixed data types (i.e., categorical and numerical) to build comprehensive behavioural models. For training the one or more ML model, the training subsystem 218 is configured to obtain one or more training datasets associated with one or more baseline logs (e.g., 30 days baseline logs) for at least one of: the one or more user behaviours and the one or more entity behaviours. In an embodiment, the one or more training datasets associated with the one or more baseline logs may indicate at least one of: one or more regular patterns including at least one of: system interactions, process executions, and critical activity frequencies.

The training subsystem 218 is further configured to analyze frequency and context of interactions with at least one of: one or more system processes, one or more critical processes, and one or more activities. The analysis of frequency and context of interactions ensures accurate clustering by capturing nuanced behavioural characteristics. The training subsystem 218 is further configured to cluster at least one of: one or more users and one or more entities, into one or more groups based on at least one of: one or more internal rules and the one or more training datasets associated with the one or more baseline logs, for identifying and segmenting the one or more malicious activities and the one or more threats.

The plurality of subsystems 110 further includes the re-training subsystem 220 that is communicatively connected to the one or more hardware processors 204. The re-training subsystem 220 is configured to re-train the one or more ML models. For re-training the one or more ML models, the re-training subsystem 220 is initially configured to continuously assess the one or more baseline logs for at least one of: the one or more user behaviours and the one or more entity behaviours to indicate one or more dynamic changes in at least one of: the one or more user behaviours and the one or more entity behaviours.

The re-training subsystem 220 is further configured to continuously monitor at least one of: the one or more user behaviours and the one or more entity behaviours, to validate performance of the one or more ML models based on one or more feedback received from one or more analysts. In other words, the re-training subsystem 220 is configured to monitor at least one of: the one or more user behaviours and the one or more entity behaviours, ensuring that deviations from established norms are identified promptly. The one or more feedback from the one or more analysts, are incorporated into the monitoring process to validate and refine the model's output.

The re-training subsystem 220 is further configured to update one or more categories associated with the one or more malicious activities, to synchronize/align with current organizational and operational needs. In an embodiment, the one or more categories associated with the one or more malicious activities comprise at least one of: system, critical and non-critical. The process categorization helps the one or more models focus on meaningful behaviours while reducing noise and irrelevant data. The re-training subsystem 220 is further configured to fine-tune the one or more ML models to optimize adaptability and mitigate false positives based on the one or more feedback received from the one or more analysts. The re-training subsystem 220 is further configured to re-train the one or more ML models with updated data associated with the one or more logs to determine for changes in at least one of: the one or more user behaviours and the one or more entity behaviours.

The plurality of subsystems 110 further includes the anomaly detecting subsystem 214 that is communicatively connected to the one or more hardware processors 204. The anomaly detecting subsystem 214 is configured to correlate one or more alerts associated with the one or more malicious activities that are identified from at least one of: the alarm engine, the correlation engine, a threat engine, the UEBA engine, with the one or more historical alerts (e.g. 30 days alerts) associated with the one or more historical malicious activities, to detect the one or more patterns and trends indicating the one or more anomalies that may span across multiple systems and events, using the extended threat detection (XTD) engine.

The correlation between the one or more alerts associated with the one or more malicious activities and the one or more historical alerts associated with the one or more historical malicious activities, may create a synergistic detection effect, leveraging insights from the one or more engines to uncover sophisticated attack patterns that might otherwise remain undetected. In an embodiment, the XTD engine may optimize the overall detection and response capabilities of the ML-based system 104, ensuring a comprehensive approach to identifying and mitigating threats, by synchronizing data from multiple detection layers.

Typically, persistent and advanced threats often unfold over extended periods, making the ML-based system 104 challenging to detect using individual engines that process data over shorter durations. In order to overcome the situation, the XTD Engine is configured to correlate alerts generated by the one or more detection engines, providing a comprehensive view of potential threats over time. The XTD Engine is configured to retain the one or more alerts for up to 365 days, enabling long-term analysis and historical threat assessment. The XTD Engine is further configured to utilize the capability to perform correlation across the one or more alerts generated over the past 30 days, identifying persistent and advanced threats that may not be apparent through the analysis of individual engines alone. By bridging the gap between short-term detection and long-term analysis, the XTD Engine is configured to optimize/enhance the platform's ability to uncover sophisticated attack patterns, providing a robust defence against evolving threats.

The plurality of subsystems 110 further includes the output subsystem 216 that is communicatively connected to the one or more hardware processors 204. The output subsystem 216 is configured to provide the one or more anomalies, as the output, to the one or more end users on the one or more user interfaces associated with the one or more electronic devices 102 associated with the one or more end users. The output subsystem 216 serves as a final stage of the ML-based system 104, ensuring that the identified malicious activities and detected one or more anomalies are made available to the one or more end users in a user-friendly and accessible manner.

The plurality of subsystems 110 further includes the domain converting subsystem 222 that is communicatively connected to the one or more hardware processors 204. The domain converting subsystem 222 is configured to obtain the one or more alerts associated with the one or more malicious activities, from the one or more engines including at least one of: the alarm engine, the correlation engine, the threat engine, and the UEBA engine. The domain converting subsystem 222 is further configured to transform one or more formats of the one or more alerts into one or more actionable insights in a common format, using a cross-domain alert converter engine.

The cross-domain alert converter engine is configured to enable seamless correlation between the one or more alerts from the one or more engines by standardizing key parameters. The cross-domain alert converter engine is configured to ensure that standard fields are captured consistently across all major alert sources (i.e., the one or more engines), providing a unified structure for analysis. Since the root cause of an anomaly typically originates from either a user or a device, the cross-domain alert converter engine focuses on extracting and normalizing a standard set of parameters related to users and devices as available in the alert data. This standardization forms the foundation for effective cross-domain alert correlation, enhancing the ability to detect complex attack patterns across diverse environments.

In other words, the cross-domain alert converter engine is a core enabler of cross-domain integration, providing seamless interoperability, comprehensive threat visibility, and a unified approach to cybersecurity across the organization's entire digital ecosystem. The cross-domain alert converter engine is configured to significantly enhance the integration capabilities of the ML-based system 104 by seamlessly bringing together data from multiple domain-specific security solutions into a unified platform. The cross-domain alert converter engine is configured to convert and normalize the one or more alerts from diverse systems including at least one of: Fraud and Risk Management (FRM), Anti-Money Laundering (AML) Solutions, Biometric Authentication Systems, Supply Chain Risk Management Systems, Mobile Threat Defense (MTD) Systems, Industrial Control Systems (ICS) Security, Network Detection & Response (NDR), Endpoint Detection and Response (EDR), and Cloud Security Posture Management (CSPM), into the common format that the ML-based system 104 may analyze and correlate in real-time.

By leveraging the cross-domain alert converter engine, the ML-based system 104 overcomes the challenge of fragmented data silos, enabling a comprehensive view of all security events across the organization. The cross-domain alert converter engine ensures that the one or more alerts from the one or more engine sources are translated into actionable insights, allowing for the detection of sophisticated attack patterns that span one or more domains. This capability reduces the likelihood of false positives and alert fatigue by prioritizing and enriching the one or more alerts with context from one or more integrated systems.

The ML-based system 104 utilizes one or more parameters to reduce false positives across the one or more engines. For example, the ML-based system 104 is configured to adjust thresholds for specific use cases based on historical data to avoid triggering alerts on benign activities. The ML-based system 104 is further configured to utilize metadata including at least one of: user role, device type, location, and the like, to add context and to eliminate irrelevant alerts. The ML-based system 104 is further configured to continuously update for detection rules to align with evolving threats and operational baselines. The ML-based system 104 is further configured to generate a risk score to be incorporated for prioritizing high-risk alerts and suppress low-impact ones.

The ML-based system 104 is further configured to establish dynamic baselines for user and entity behaviours using the historical data. The ML-based system 104 is further configured to process for incorporating the one or more feedback from the one or more analysts to optimize the one or more anomaly detection models continuously. The ML-based system 104 is further configured to leverage the external threat intelligence feeds to validate and enhance alert accuracy. The ML-based system 104 is further configured to maintain updated whitelists for trusted users, devices, and processes. The ML-based system 104 is further configured to process for periodically reviewing engine configurations and detection logic to ensure optimal performance.

FIG. 3 is an exemplary view 300 depicting the detection of the one or more anomalies in the one or more user behaviours, in accordance with an embodiment of the present disclosure. The exemplary view shows that the risk score (i.e., an individual risk score) is computed/generated for one or more alerts generated by each ML model of the one or more ML models 302. For example, the risk score is generated as 0.1 for each alert generated by the login anomaly based ML model, the risk score is generated as 0.3 for an alert generated by the geo location anomaly based ML model, the risk score is generated as 0.1 for an alert generated by the lateral movement based ML model, the risk score is generated as 0.1 for an alert generated by the privilege escalation based ML model, and the risk score is generated as 0.4 for an alert generated by the process based ML model.

Further, the severity 304 of the malicious activities are categorized based on the risk scores 306. For example, the risk score 0.5 may indicate a process severity as critical and defined as “malicious process and command line process”, the risk score 0.3 may indicate the process severity as high level and defined as “critical process”, the risk score 0.2 may indicate the process severity as medium level and defined as “data sharing application and other non-categorized process”, and the risk score 0.1 may indicate the process severity as low level and defined as “software utility, user utility and browser”.

Further, the exemplary shows that if the risk score exceeds 0.6, then the risk against the entity may be indicated as critical (as shown in 308). If the risk score exceeds 0.4 ad lower than 0.6, then the risk against the entity may be indicated as high, If the risk score exceeds 0.25 and lower than 0.4, then the risk against the entity may be indicated as medium. If the risk score is lower than 0.25, then the risk against the entity may be indicated as low.

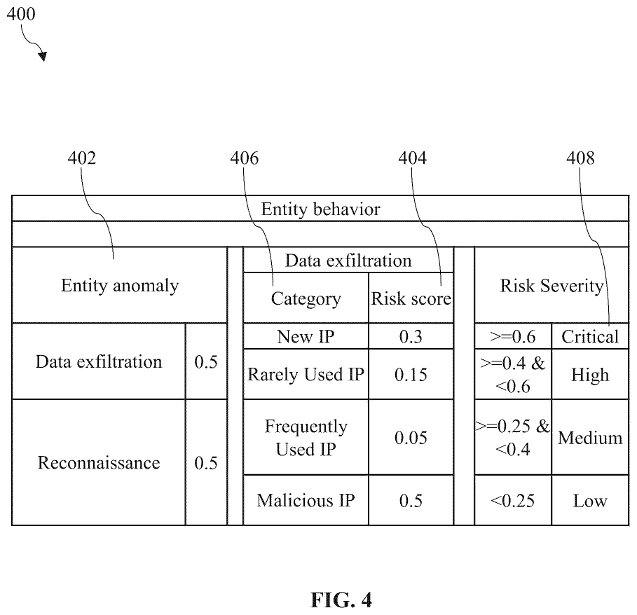

FIG. 4 is an exemplary view 400 depicting the detection of the one or more anomalies in the one or more entity behaviours, in accordance with an embodiment of the present disclosure. The exemplary view shows that the risk score (i.e., the individual risk score) is generated for the risk detection techniques 402 including at least one of: data exfiltration technique and reconnaissance technique. For example, the score is set as 0.5 for data exfiltration technique and the reconnaissance technique. FIG. 4 shows that the risk score 404 is generated to categorize the entity 406 using the exfiltration technique. For instance, the risk score is generated as 0.3 to categorize the entity as “new IP”, the risk score is generated as 0.15 to categorize the entity as “” arely used IP”, the risk score is generated as 0.05 to categorize the entity as “” requently used IP”, and the risk score is generated as 0.5 to categorize the entity as “”malicious IP”.

Further, the exemplary shows that if the risk score exceeds 0.6, then the risk against the entity may be indicated as critical (as shown in 408). If the risk score exceeds 0.4 ad lower than 0.6, then the risk against the entity may be indicated as high, If the risk score exceeds 0.25 and lower than 0.4, then the risk against the entity may be indicated as medium. If the risk score is lower than 0.25, then the risk against the entity may be indicated as low.

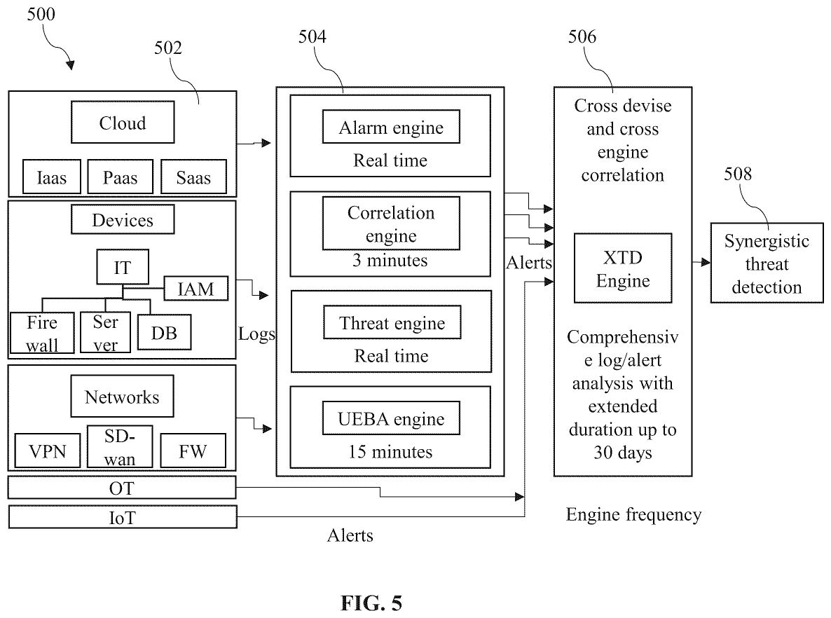

FIG. 5 is a process flow 500 depicting the detection of one or more patterns and trends indicating the one or more anomalies, using the extended threat detection (XTD) engine, in accordance with an embodiment of the present disclosure. At step 502, the one or more logs are obtained from the one or more log data sources 108 including at least one of: cloud, one or more devices, one or more networks, operational technologies, Internet of Things (IoTs), and the like. At step 504, the one or more malicious activities are identified from the one or more logs. For example, the one or more malicious activities are identified in real-time by analyzing the data associated with the one or more logs using the alarm engine. The one or more malicious activities are identified by correlating each log with the one or more logs over the predetermined time window (e.g., three minute time window) using the correlation engine with the predefined analysis and detection rules.

The one or more malicious activities are identified in real-time by utilizing at least one of: one or more external threat intelligent sources and one or more internal threat intelligent sources, using the threat engine. The one or more malicious activities are identified by analyzing the data associated with the one or more logs that are obtained over the predetermined time duration (e.g., 15 minutes), using the UEBA engine with the one or more machine learning (ML) models.

At step 506, the one or more alerts associated with the one or more malicious activities that are identified from at least one of: the alarm engine, the correlation engine, the threat engine, the UEBA engine, are correlated with the one or more historical alerts (e.g., 30 days alerts) associated with one or more historical malicious activities, to detect the one or more patterns and trends indicating the one or more anomalies (as shown in step 508), using the XTD engine.

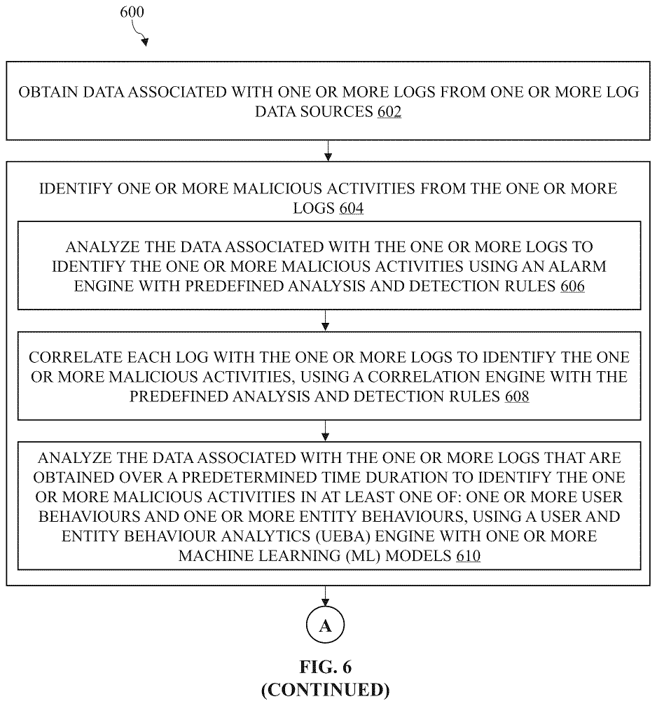

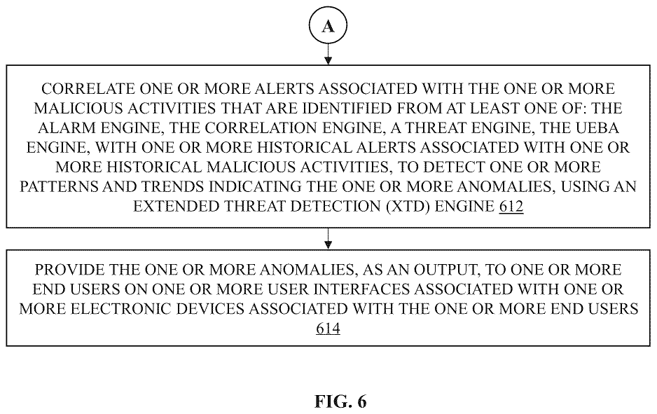

FIG. 6 is a flow chart illustrating an ML-based method 600 for automatically detecting the one or more anomalies, in accordance with an embodiment of the present disclosure.

At step 602, the data associated with the one or more logs are obtained from the one or more log data sources 108. At step 604, the one or more malicious activities are identified from the one or more logs, by at least one of: (a) analyzing the data associated with the one or more logs to identify the one or more malicious activities using the alarm engine with predefined analysis and detection rules, as shown in step 606; (b) correlating each log with the one or more logs to identify the one or more malicious activities, using the correlation engine with the predefined analysis and detection rules, as shown in step 608; and (c) analyzing the data associated with the one or more logs that are obtained over the predetermined time duration to identify the one or more malicious activities in at least one of: the one or more user behaviours and the one or more entity behaviours, using the UEBA engine with the one or more machine learning (ML) models, as shown in step 610.

At step 612, the one or more alerts associated with the one or more malicious activities that are identified from at least one of: the alarm engine, the correlation engine, a threat engine, the UEBA engine, are correlated with the one or more historical alerts associated with the one or more historical malicious activities, to detect the one or more patterns and trends indicating the one or more anomalies, using the XTD engine. At step 614, the one or more anomalies, are provided as the output, to the one or more end users on the one or more user interfaces associated with the one or more electronic devices 102 associated with the one or more end users.

Numerous advantages of the present disclosure may be apparent from the discussion above. In accordance with the present disclosure, the ML-based system 104 can detect threats across one or more domains (e.g. cybersecurity, physical security, financial fraud) by correlating patterns that may be missed by domain-specific systems. By analyzing and correlating the one or more alerts over an extended period, the ML-based system 104 can distinguish between significant patterns and isolated false positives, which helps in reducing the number of irrelevant alerts. The ML-based system 104 is configured to reduce alert fatigue for security teams, allowing them to focus on genuine threats and improving overall efficiency. The ML-based system 104 has ability to correlate the one or more alerts over a 30-day period, which allows the ML-based system 104 to identify persistent threats that may not be apparent when looking at isolated incidents. This provides a comprehensive view of potential risks that could be building up over time. The ML-based system 104 provides enhanced visibility into long-term threats, enabling proactive measures before the threats become critical.

The ML-based system 104 is configured to integrate a plurality of detection methods through the one or more engines (e.g., signature-based, anomaly-based, behavioural analysis) to create a layered defence. This multi-method approach ensures that if a threat evades one detection method, the threat can still be caught by another method. The ML-based system 104 may have optimized capabilities of detecting sophisticated threats that would otherwise slip through the cracks in a single-method system. The ML-based system 104 has capability to aggregate and correlate threats over a 30-day period, which enables the ML-based system 104 to reveal patterns or anomalies that may be missed with real-time detection alone. This extended historical analysis aids in identifying threats that evolve gradually or are intentionally designed to avoid swift detection. Enhanced detection of hidden or slow-moving threats that might otherwise go unnoticed, offering a deeper level of security insight and fortifying the overall defense strategy.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer-readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random-access memory (RAM), a read-only memory (ROM), a rigid magnetic disk and an optical disk. Current examples of optical disks include compact disk-read only memory (CD-ROM), compact disk-read/write (CD-R/W) and DVD.

Input/output (I/O) devices (including but not limited to keyboards, displays, pointing devices, etc.) can be coupled to the ML-based system 104 either directly or through intervening I/O controllers. Network adapters may also be coupled to the ML-based system 104 to enable the data processing system to become coupled to other data processing systems or remote printers or storage devices through intervening private or public networks. Modems, cable modem and Ethernet cards are just a few of the currently available types of network adapters.

A representative hardware environment for practicing the embodiments may include a hardware configuration of an information handling/ML-based system 104 in accordance with the embodiments herein. The ML-based system 104 herein comprises at least one processor or central processing unit (CPU). The CPUs are interconnected via the system bus 208 to various devices including at least one of: a random-access memory (RAM), read-only memory (ROM), and an input/output (I/O) adapter. The I/O adapter can connect to peripheral devices, including at least one of: disk units and tape drives, or other program storage devices that are readable by the ML-based system 104. The ML-based system 104 can read the inventive instructions on the program storage devices and follow these instructions to execute the methodology of the embodiments herein.

The ML-based system 104 further includes a user interface adapter that connects a keyboard, mouse, speaker, microphone, and/or other user interface device including a touch screen device (not shown) to the bus to gather user input. Additionally, a communication adapter connects the bus to a data processing network, and a display adapter connects the bus to a display device which may be embodied as an output device including at least one of: a monitor, printer, or transmitter, for example.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

What is claimed is:

1. A machine-learning based (ML-based) method for automatically detecting one or more anomalies, the ML-based method comprising:
obtaining, by one or more hardware processors, data associated with one or more logs from one or more log data sources;
identifying, by the one or more hardware processors, one or more malicious activities from the one or more logs, by at least one of:
analyzing, by the one or more hardware processors, the data associated with the one or more logs to identify the one or more malicious activities using an alarm engine with predefined analysis and detection rules;
correlating, by the one or more hardware processors, each log with the one or more logs to identify the one or more malicious activities, using a correlation engine with the predefined analysis and detection rules; and
analyzing, by the one or more hardware processors, the data associated with the one or more logs that are obtained over a predetermined time duration to identify the one or more malicious activities in at least one of: one or more user behaviours and one or more entity behaviours, using a user and entity behaviour analytics (UEBA) engine with one or more machine learning (ML) models;
correlating, by the one or more hardware processors, one or more alerts associated with the one or more malicious activities that are identified from at least one of: the alarm engine, the correlation engine, a threat engine, the UEBA engine, with one or more historical alerts associated with one or more historical malicious activities, to detect one or more patterns and trends indicating the one or more anomalies, using an extended threat detection engine; and
providing, by the one or more hardware processors, the one or more anomalies, as an output, to one or more end users on one or more user interfaces associated with one or more electronic devices associated with the one or more end users.

2. The ML-based method of claim 1, wherein identifying the one or more malicious activities using the alarm engine, comprises:
obtaining, by the one or more hardware processors, the data associated with the one or more logs from the one or more log data sources;
comparing, by the one or more hardware processors, the data associated with the one or more logs, with the predefined analysis and detection rules;
identifying, by the one or more hardware processors, the one or more malicious activities upon comparison of the data associated with the one or more logs, with the predefined analysis and detection rules.

3. The ML-based method of claim 1, wherein identifying the one or more malicious activities using the correlation engine, comprises:
obtaining, by the one or more hardware processors, the data associated with the one or more logs from the one or more log data sources;
correlating, by the one or more hardware processors, each event associated with each log, with one or more events associated with the one or more logs;
analyzing, by the one or more hardware processors, one or more relationships and patterns among the one or more events associated with the one or more logs over a predetermined time window, upon comparison of each event associated with each log, with the one or more events associated with the one or more logs; and
identifying, by the one or more hardware processors, the one or more malicious activities based on the analysis of the one or more relationships and patterns among the one or more events, using the correlation engine.

4. The ML-based method of claim 1, further comprising:
utilizing, by the one or more hardware processors, at least one of: one or more external threat intelligent sources and one or more internal threat intelligent sources, for identifying the one or more malicious activities and one or more threats, using the threat engine; and
integrating, by the one or more hardware processors, the one or more external threat intelligent sources and one or more internal threat intelligent sources, to optimize a process of identifying the one or more malicious activities and the one or more threats, using the threat engine.

5. The ML-based method of claim 1, wherein identifying the one or more malicious activities in at least one of: the one or more user behaviours and the one or more entity behaviours, using the UEBA engine, comprises:
obtaining, by the one or more hardware processors, the one or more alerts associated with the one or more malicious activities, generated from the one or more ML models, wherein the one or more ML models comprise at least one of: a login anomaly based ML model, a process anomaly based ML model, a geo location anomaly based ML model, a lateral movement based ML model, and a privilege escalation based ML model;
generating, by the one or more hardware processors, one or more individual risk scores with one or more individual weights for one or more alerts generated by each ML model of the one or more ML models, based on severity and context of the one or more malicious activities;
computing, by the one or more hardware processors, one or more overall risk scores with one or more overall weights for one or more combinations of the one or more alerts generated by the one or more ML models, based on the severity and context of the one or more malicious activities; and
identifying, by the one or more hardware processors, the one or more malicious activities based on an optimized risk score with optimized weight among the one or more overall risk scores with the one or more overall weights computed for the one or more combinations of the one or more alerts.

6. The ML-based method of claim 1, further comprising training, by the one or more hardware processors, the one or more ML models within the UEBA engine, by:
obtaining, by the one or more hardware processors, one or more training datasets associated with one or more baseline logs for at least one of: the one or more user behaviours and the one or more entity behaviours, wherein the one or more training datasets associated with the one or more baseline logs indicate at least one of: one or more regular patterns comprising at least one of: system interactions, process executions, and critical activity frequencies;
analyzing, by the one or more hardware processors, frequency and context of interactions with at least one of: one or more system processes, one or more critical processes, and one or more activities; and
clustering, by the one or more hardware processors, at least one of: one or more users and one or more entities, into one or more groups based on at least one of: one or more internal rules and the one or more training datasets associated with the one or more baseline logs, for identifying and segmenting the one or more malicious activities and the one or more threats.

7. The ML-based method of claim 6, further comprising re-training, by the one or more hardware processors, the one or more ML models within the UEBA engine, by:
continuously assessing, by the one or more hardware processors, the one or more baseline logs for at least one of: the one or more user behaviours and the one or more entity behaviours to indicate one or more dynamic changes in at least one of: the one or more user behaviours and the one or more entity behaviours;
continuously monitoring, by the one or more hardware processors, at least one of: the one or more user behaviours and the one or more entity behaviours, to validate performance of the one or more ML models based on one or more feedback received from one or more analysts;
updating, by the one or more hardware processors, one or more categories associated with the one or more malicious activities, to synchronize with current organizational and operational needs, wherein the one or more categories associated with the one or more malicious activities comprise at least one of: system, critical and non-critical;
fine-tuning, by the one or more hardware processors, the one or more ML models to optimize adaptability and mitigate false positives based on the one or more feedback received from the one or more analysts; and
re-training, by the one or more hardware processors, the one or more ML models with updated data associated with the one or more logs to determine for changes in at least one of: the one or more user behaviours and the one or more entity behaviours.

8. The ML-based method of claim 1, further comprising:
obtaining, by the one or more hardware processors, the one or more alerts associated with the one or more malicious activities, from one or more engines comprising at least one of: the alarm engine, the correlation engine, the threat engine, and the UEBA engine; and
transforming, by the one or more hardware processors, one or more formats of the one or more alerts into one or more actionable insights in a common format, using a cross-domain alert converter engine.

9. A machine learning based (ML-based) system for automatically detecting one or more anomalies, the ML-based system comprising:
one or more hardware processors;
a memory coupled to the one or more hardware processors, wherein the memory comprises a plurality of subsystems in form of programmable instructions executable by the one or more hardware processors, and wherein the plurality of subsystems comprises:
a data obtaining subsystem configured to obtain data associated with one or more logs from one or more log data sources;
a malicious activities identifying subsystem configured to identify one or more malicious activities from the one or more logs by at least one of:
analyzing the data associated with the one or more logs to identify the one or more malicious activities using an alarm engine with predefined analysis and detection rules;
correlating each log with the one or more logs to identify the one or more malicious activities, using a correlation engine with the predefined analysis and detection rules; and
analyzing, by the one or more hardware processors, the data associated with the one or more logs that are obtained over a predetermined time duration to identify the one or more malicious activities in at least one of: one or more user behaviours and one or more entity behaviours, using a user and entity behaviour analytics (UEBA) engine with one or more machine learning (ML) models;
an anomaly detecting subsystem configured to correlate one or more alerts associated with the one or more malicious activities that are identified from at least one of: the alarm engine, the correlation engine, a threat engine, the UEBA engine, with one or more historical alerts associated with one or more historical malicious activities, to detect one or more patterns and trends indicating the one or more anomalies, using an extended threat detection engine; and
an output subsystem configured to provide the one or more anomalies, as an output, to one or more end users on one or more user interfaces associated with one or more electronic devices associated with the one or more end users.

10. The ML-based system of claim 9, wherein in identifying the one or more malicious activities using the alarm engine, the malicious activities identifying subsystem is configured to:
obtain the data associated with the one or more logs from the one or more log data sources;
compare the data associated with the one or more logs, with the predefined analysis and detection rules;
identify the one or more malicious activities upon comparison of the data associated with the one or more logs, with the predefined analysis and detection rules.

11. The ML-based system of claim 9, wherein in identifying the one or more malicious activities using the correlation engine, the malicious activities identifying subsystem is further configured to:
obtain the data associated with the one or more logs from the one or more log data sources;
correlate each event associated with each log, with one or more events associated with the one or more logs;
analyze one or more relationships and patterns among the one or more events associated with the one or more logs over a predetermined time window, upon comparison of each event associated with each log, with the one or more events associated with the one or more logs; and
identify the one or more malicious activities based on the analysis of the one or more relationships and patterns among the one or more events, using the correlation engine.

12. The ML-based system of claim 9, wherein the malicious activities identifying subsystem is further configured to:
utilize at least one of: one or more external threat intelligent sources and one or more internal threat intelligent sources, for identifying the one or more malicious activities and one or more threats, using the threat engine; and
integrate the one or more external threat intelligent sources and one or more internal threat intelligent sources, to optimize a process of identifying the one or more malicious activities and the one or more threats, using the threat engine.

13. The ML-based system of claim 9, wherein in identifying the one or more malicious activities in at least one of: the one or more user behaviours and the one or more entity behaviours, using the UEBA engine, the malicious activities identifying subsystem is further configured to:
obtain the one or more alerts associated with the one or more malicious activities, generated from the one or more ML models, wherein the one or more ML models comprise at least one of: a login anomaly based ML model, a process anomaly based ML model, a geo location anomaly based ML model, a lateral movement based ML model, and a privilege escalation based ML model;
generate one or more individual risk scores with one or more individual weights for one or more alerts generated by each ML model of the one or more ML models, based on severity and context of the one or more malicious activities;
compute one or more overall risk scores with one or more overall weights for one or more combinations of the one or more alerts generated by the one or more ML models, based on the severity and context of the one or more malicious activities; and
identify the one or more malicious activities based on an optimized risk score with optimized weight among the one or more overall risk scores with the one or more overall weights computed for the one or more combinations of the one or more alerts.

14. The ML-based system of claim 9, further comprising a training subsystem configured to train the one or more ML models within the UEBA engine, by:
obtaining one or more training datasets associated with one or more baseline logs for at least one of: the one or more user behaviours and the one or more entity behaviours, wherein the one or more training datasets associated with the one or more baseline logs indicate at least one of: one or more regular patterns comprising at least one of: system interactions, process executions, and critical activity frequencies;
analyzing frequency and context of interactions with at least one of: one or more system processes, one or more critical processes, and one or more activities; and
clustering at least one of: one or more users and one or more entities, into one or more groups based on at least one of: one or more internal rules and the one or more training datasets associated with the one or more baseline logs, for identifying and segmenting the one or more malicious activities and the one or more threats.

15. The ML-based system of claim 14, further comprising a re-training subsystem configured to re-train the one or more ML models within the UEBA engine, by:
continuously assessing the one or more baseline logs for at least one of: the one or more user behaviours and the one or more entity behaviours to indicate one or more dynamic changes in at least one of: the one or more user behaviours and the one or more entity behaviours;
continuously monitoring at least one of: the one or more user behaviours and the one or more entity behaviours, to validate performance of the one or more ML models based on one or more feedback received from one or more analysts;
updating one or more categories associated with the one or more malicious activities, to synchronize with current organizational and operational needs, wherein the one or more categories associated with the one or more malicious activities comprise at least one of: system, critical and non-critical;
fine-tuning the one or more ML models to optimize adaptability and mitigate false positives based on the one or more feedback received from the one or more analysts; and
re-training the one or more ML models with updated data associated with the one or more logs to determine for changes in at least one of: the one or more user behaviours and the one or more entity behaviours.

16. The ML-based system of claim 9, further comprising a domain converting subsystem configured to:
obtain the one or more alerts associated with the one or more malicious activities, from one or more engines comprising at least one of: the alarm engine, the correlation engine, the threat engine, and the UEBA engine; and
transform one or more formats of the one or more alerts into one or more actionable insights in a common format, using a cross-domain alert converter engine.

17. A non-transitory computer-readable storage medium having instructions stored therein that when executed by one or more hardware processors, cause the one or more hardware processors to execute operations of:
obtaining data associated with one or more logs from one or more log data sources;
identifying, by the one or more hardware processors, one or more malicious activities from the one or more logs by at least one of:
analyzing, by the one or more hardware processors, the data associated with the one or more logs to identify the one or more malicious activities using an alarm engine with predefined analysis and detection rules;
correlating, by the one or more hardware processors, each log with the one or more logs to identify the one or more malicious activities, using a correlation engine with the predefined analysis and detection rules; and
analyzing, by the one or more hardware processors, the data associated with the one or more logs that are obtained over a predetermined time duration to identify the one or more malicious activities in at least one of: one or more user behaviours and one or more entity behaviours, using a user and entity behaviour analytics (UEBA) engine with one or more machine learning (ML) models;
correlating, by the one or more hardware processors, one or more alerts associated with the one or more malicious activities that are identified from at least one of: the alarm engine, the correlation engine, a threat engine, the UEBA engine, with one or more historical alerts associated with one or more historical malicious activities, to detect one or more patterns and trends indicating the one or more anomalies, using an extended threat detection engine; and
providing, by the one or more hardware processors, the one or more anomalies, as an output, to one or more end users on one or more user interfaces associated with one or more electronic devices associated with the one or more end users.

18. The non-transitory computer-readable storage medium of claim 17, wherein identifying the one or more malicious activities in at least one of: the one or more user behaviours and the one or more entity behaviours, using the UEBA engine, comprises:
obtaining the one or more alerts associated with the one or more malicious activities, generated from the one or more ML models, wherein the one or more ML models comprise at least one of: a login anomaly based ML model, a process anomaly based ML model, a geo location anomaly based ML model, a lateral movement based ML model, and a privilege escalation based ML model;
generating one or more individual risk scores with one or more individual weights for one or more alerts generated by each ML model of the one or more ML models, based on severity and context of the one or more malicious activities;
computing one or more overall risk scores with one or more overall weights for one or more combinations of the one or more alerts generated by the one or more ML models, based on the severity and context of the one or more malicious activities; and
identifying the one or more malicious activities based on an optimized risk score with optimized weight among the one or more overall risk scores with the one or more overall weights computed for the one or more combinations of the one or more alerts

19. The non-transitory computer-readable storage medium of claim 17, further comprising training the one or more ML models within the UEBA engine, by:
obtaining one or more training datasets associated with one or more baseline logs for at least one of: the one or more user behaviours and the one or more entity behaviours, wherein the one or more training datasets associated with the one or more baseline logs indicate at least one of: one or more regular patterns comprising at least one of: system interactions, process executions, and critical activity frequencies;
analyzing frequency and context of interactions with at least one of: one or more system processes, one or more critical processes, and one or more activities; and
clustering at least one of: one or more users and one or more entities, into one or more groups based on at least one of: one or more internal rules and the one or more training datasets associated with the one or more baseline logs, for identifying and segmenting the one or more malicious activities and one or more threats.

20. The non-transitory computer-readable storage medium of claim 19, further comprising re-training the one or more ML models within the UEBA engine, by:
continuously assessing the one or more baseline logs for at least one of: the one or more user behaviours and the one or more entity behaviours to indicate one or more dynamic changes in at least one of: the one or more user behaviours and the one or more entity behaviours;
continuously monitoring at least one of: the one or more user behaviours and the one or more entity behaviours, to validate performance of the one or more ML models based on one or more feedback received from one or more analysts;
updating one or more categories associated with the one or more malicious activities, to synchronize with current organizational and operational needs, wherein the one or more categories associated with the one or more malicious activities comprise at least one of: system, critical and non-critical;
fine-tuning the one or more ML models to optimize adaptability and mitigate false positives based on the one or more feedback received from the one or more analysts; and
re-training the one or more ML models with updated data associated with the one or more logs to determine for changes in at least one of: the one or more user behaviours and the one or more entity behaviours.
